(19) United States
(12) Patent Application Publication
(10) Pub. No.: US 2021/0342508 A1
(43) Pub. Date: Nov. 4, 2021

(54) SYSTEMS AND METHODS FOR DESIGNING COMPOSITIONALLY GRADED ALLOYS

(71) Applicant: The Texas A&M University System, College Station, TX (US)

(72) Inventors: Raymundo Arroyave, College Station, TX (US); Tanner Q. Kirk, College Station, TX (US); Richard J. Malak, College Station, TX (US)

(21) Appl. No.: 17/333,726

(22) Filed: May 28, 2021

Related U.S. Application Data
(60) Provisional application No. 60/031,855, filed on Nov. 29, 1996.

(51) Int. Cl. G06F 30/27; G06F 30/23; G06N 5/00; G06N 20/10

(52) U.S. Cl. CPC G06F 30/27; G06F 30/23; G06F 2111/20; G06N 20/10; G06N 5/003

(57) ABSTRACT

A system and method for determining optimal configuration of a functionally graded material is provided. A multi-dimensional configuration space can be sampled to create a model including an obstacle and free space. Using a cost function including a lack of monotonicity objective, and a path planning algorithm, a gradient path for a functionally graded materially can be determined through the free space in the configuration space. The resulting gradient path can be used to create functionally graded materials with desirable combinations of characteristics.

### CROSS-REFERENCE TO RELATED APPLICATION

This application claims priority to and benefit of U.S. provisional patent application Ser. No. 60/031,855 filed May 29, 2020, which is fully incorporated by reference and made a part hereof.

### STATEMENT REGARDING GOVERNMENT SUPPORT

This invention was made with governments support under sponsor award NSF NRT No 1545403, Data-Enabled Discovery and Design of Energy Materials, D3EM, awarded by the National Science foundation. The government has certain rights in the invention.

### BACKGROUND

Materials that leverage spatial property gradients, or Functionally Graded Materials (FGMs), have been the subject of research, but FGMs are now a rapidly expanding area of research due to the emergence of additive manufacturing. These materials can be used to achieve contradictory performance requirements in the same part. For example, metal ceramic composites trade mechanical strength for thermal resistance, while graded polymers balance density and flexibility. FGMs can be created by varying material composition, processing, or structure and have been demonstrated in polymers, ceramics, and metals.

Compositionally graded alloys are a special class of FGMs that exhibit the high-performance characteristics of metals, but offer larger and more varied changes in properties than grading structure alone. Directed Energy Deposition (DED) greatly simplified the construction of such materials by enabling manufacturers to change the deposited composition layer by layer. During the DED process, powders of various compositions are deposited on the build and then solidified by a high energy laser. The composition of the build can be easily con-trolled by controlling the ratio of deposited powders.

In recent years, compositionally graded alloys have been printed using the DED process. Many of these works linearly grade composition directly between two material endpoints. While some of these gradients have been successful, they can encounter deleterious phases in the gradient path that can lead to undesirable properties or cracking during the build process. Carroll et al. and Chen et al. attempted linear gradients between 304L stainless steel and Inconel 625, but observed secondary phases that led to cracks and increased micro-hardness. Reichardt et al. attempted a gradient from 304L stainless steel to Ti-6Al-4V with a pure V interlayer, but experienced significant cracking due to the formation of the brittle sigma phase. Bobbio et al. linearly graded between Ti-6Al-4V and Invar and also saw cracking due to the formation of brittle intermetallics. Meng at al. manufactured a linear gradient from Ti-6Al-4V to Invar that, once again, cracked due to the formation of secondary phases.

Hofmann et al. proposed a strategy to avoid the formation of these detrimental secondary phases. In that work, the authors propose using phase diagrams as maps to plan gradient paths so that undesirable phases are avoided. The strategy was employed in Reichardt et al. when CALculation of PHAse Diagrams (CALPHAD) software was used to generate an isothermal ternary phase diagram in the Fe—Cr—V system. This phase diagram was then used to plan a new gradient from pure V to 304L stainless steel that avoids the sigma phase region the authors encountered in the linear gradient. Recent works have built on this strategy by using Scheil ternary projections, which provide more accurate predictions of undesirable phase regions that consider the rapid solidification conditions of additive manufacturing.

While this strategy can be useful for visualizing and planning simple gradients or sections of more complicated gradients, it has significant limitations. One significant limitation is the inability to visualize more than three elements at a time when most gradient design problems involve six or more elements. For example, a gradient between 304L stainless steel and Ti-6Al-4V involves at least six elements (Fe, Ni, Cr, Ti, Al, and V) which have twenty possible ternary combinations. It would be difficult to visualize this entire composition space with any two-dimensional illustration. Such phase diagrams are also isothermal or temperature projections, limiting the ability to account for all the temperatures a gradient might experience during manufacturing or operation.

Current methodologies cannot optimize gradients for properties, despite the fact that the properties of a Functionally Graded Material are of importance to its design. While the properties of many polymer or metal-ceramic FGMs vary linearly or smoothly across the gradient region, compositionally graded alloys often have highly nonlinear property gradients. Properties also can change more drastically and unpredictably with composition than with structure. Property gradients that are not obvious design objectives can also be important to the success of an FGM. For example, the discontinuities in stiffness and thermal expansion introduced by secondary phases are the very reason for their detriment to part integrity.

Therefore, what is needed are systems and methods to produce compositional paths with desired property gradients.

### SUMMARY

To improve the design of compositionally graded materials and to overcome the limitations of conventional design techniques, systems, methods and devices are disclosed which use models to determine desirable property profiles.

In one aspect, the present disclosure relates to a method for determining an optimal configuration of a functionally graded material. In one embodiment, the method includes sampling a multi-dimensional configuration space with a thermodynamic model of phase stability to determine a plurality of samples within the configuration space, where each sample includes phase information of a composition at a distinct location within the configuration space; determining an obstacle model based on the plurality of samples, the obstacle model defining one or more obstacle regions in the configuration space with one or more undesirable material characteristics; determining a free space within the configuration space in which a subset of the plurality of samples within the free space represent one or more desired material characteristics; determining a property model that is valid within the free space of the configuration space model; determining a cost function, where the cost function is a function of a property in the property model and includes a lack of monotonicity objective; determining an optimal gradient path through the free space within the configuration space using a path planning algorithm that is configured to minimize the cost function.

In one embodiment, the cost function is further a function of one or more metrics computed from the configuration space selected from a group of metrics consisting of path length, distance from obstacles, and property gradients.

In one embodiment, the path planning algorithm is a Rapidly-exploring Random Tree algorithm.

In one embodiment, the obstacle model is determined using a machine learning classifier.

In one embodiment, the machine learning classifier is selected from a group of machine learning classifiers consisting of: a k-nearest neighbors classifier, a support vector machine classifier, a support vector data description, or an artificial neural network.

In one embodiment, the configuration space includes one or more of composition characteristics, processing characteristics, or microstructure characteristics.

In one embodiment, the one or more undesirable characteristics are is selected from a group of material properties consisting of: coefficient of thermal expansion, thermal conductivity, electrical conductivity, density, strength, ductility, hardness, stiffness, transformation stress, transformation strain, magnetization, coercivity, magnetic susceptibility, material phase, and combinations thereof representing material performance indices.

In one embodiment, each sample of the plurality of samples includes one or more material properties for the composition selected from the group consisting of: coefficient of thermal expansion, thermal conductivity, electrical conductivity, density, strength, ductility, hardness, stiffness, transformation stress, transformation strain, magnetization, coercivity, magnetic susceptibility, material phase, and combinations thereof representing material performance indices.

In one embodiment, the distinct location within configuration space is one of a plurality of locations in a regular grid, or pseudo-randomly sampled location within configuration space.

In one embodiment, the cost function further includes a path length objective.

In one embodiment, the free space within the configuration space is a complement of the one or more obstacle regions in the configuration space.

In one embodiment, the lack of monotonicity constraints is

$${LOM}_{y} ( g ) = 2 min \{ {\int }_{0}^{y} {( \frac{d g}{d y} )}^{+} d λ , {\int }_{0}^{y} {( \frac{d g}{d y} )}^{-} d λ \}$$

where, LOM_{y}(g) is an index of lack of monotonicity of the function g,

$${\int }_{0}^{y} {( \frac{d g}{d y} )}^{+}$$

dλ is an index of Lack of Increase, and

$${\int }_{0}^{y} {( \frac{d g}{d y} )}^{-}$$

dλ is an index of Lack of Decrease.

In one embodiment, the property in the property model is one or more properties selected from the group consisting of coefficient of thermal expansion, density, strength, stiffness, phase stiffness, distortion under thermal gradients, transformation stress, transformation strain, and combinations thereof representing material performance indices.

In one embodiment, the method includes determining a rate at which the composition is changed for each material in the functionally graded material based on the optimal gradient path through the configuration space.

In one embodiment, the deposition rate is determined to create the functionally graded material with a desired property profile.

In one embodiment, the desired property profile is a linear property profile, a monotonic property profile, a non-linear property profile, or a non-monotonic property profile.

In one embodiment, the method includes generating a functionally graded material based at least on the optimal gradient path using a multi-material printer.

In one embodiment, the multi-material printer is a multi-material directed energy deposition printer, a multi-material laser/E-beam powder bed fusion printer, or a multi-material extrusion and sintering system.

In one aspect, the present disclosure relates to a computer-readable medium having instructions stored that, when executed by one or more processors, cause one or more computing devices to: sample a multi-dimensional configuration space with a thermodynamic model of phase stability to determine a plurality of samples within the configuration space, where each sample includes phase information of a composition at a distinct location within the configuration space; determine an obstacle model based on the plurality of samples, the obstacle model defining one or more obstacle regions in the configuration space with one or more undesirable characteristics; determine a free space within the configuration space in which a subset of the plurality of samples within the free space represent one or more desired material characteristics;

determine a property model that is valid within the free space of the configuration space; determine a cost function, where the cost function is a function of a property in the property model and includes a lack of monotonicity objective; and determine an optimal gradient path through the free space within the configuration space using a path planning algorithm that is configured to minimize the cost function.

In one aspect, the present disclosure relates to a system including a processor, and a memory coupled to the processor, the memory storing instructions which, when executed by the processor, cause the system to: sample a multi-dimensional configuration space with a thermodynamic model of phase stability to determine a plurality of samples within the configuration space, where each sample includes phase information of a composition at a distinct location within the configuration space; determine an obstacle model based on the plurality of samples, the obstacle model defining one or more obstacle regions in the configuration space with a property; determine a free space within the configuration space in which a subset of the plurality of samples within the free space represent desired material phases; determine a property model that is valid within the configuration space model; determine a cost function, where the cost function is a function of a property in the property model and includes a lack of monotonicity objective; and determine an optimal gradient path through the free space within the configuration space using a path planning algorithm that is configured to minimize the cost function.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a simplified depiction of a feasible gradient path, σ, in a ternary (three element) composition space.

FIG. 2 illustrates a computational design methodology where CALPHAD phase information is sampled and used to train a machine learning classifier that creates a simplified model of the obstacle region, Z_{obs}, in composition space. The path planning algorithm, RRT*FN, can use the obstacle model and a specified cost function to find a desired gradient path. If the cost function employs property information, then a property model can be supplied that is valid throughout the free composition space, Z_{free}.

FIG. 3 illustrates an example of how a pathwise property profile, p(a), that is monotonic with path index, a, can be made to vary linearly with position on a part, y. Note that the region where

$$\frac{dp}{dα}$$

is highest occupies the largest region of the part. This is where deposition rate,

$$\frac{dα}{dy}$$

can be reduced to achieve a constant

$$\frac{dp}{dy} .$$

FIG. 4 is an illustration of how a pathwise property profile p(α), that is monotonic with path index can be mapped into a linear partwise property profile, p(y), or more generally, an arbitrary non-monotonic partwise property profile, p(y), that is bounded by p(zᵢₙᵢₜ) and p(z_{goal}).

FIG. 5 is an illustration of the surface of a synthetic property model, p(x1, x2), in x1 and x2 dimensions. The surface is generally monotonic with x1 and x2 except for the non-monotonic region formed by the semi-ellipsoid.

FIG. 6 is an illustration of paths planned from zᵢₙᵢₜ=(1, 1) to z_{goal}=(0, 0) to examine the effect of the weighting parameter w in the proposed cost function, seen in Eq. 12. Note that the paths corresponding to w=10⁻⁶, 10⁻⁵, 10⁻⁴, and 10⁻³ can be the same.

FIG. 7 illustrates the value of the synthetic property, p(x1, x2), along several planned paths. Note that the property profiles where w=10⁻⁶, 10⁻⁵, 10⁻⁴, and 10⁻³ can be the same.

FIG. 8 illustrates paths planned by RRT*FN to be optimal with respect to two cost functions: one intended to find the shortest path and the other to find the shortest path that has a monotonic CTE profile. The obstacle region (Z_{obs}) and the values of CTE throughout the composition space are also plotted.

FIG. 9 illustrates the CTE profiles along both paths.

FIG. 10 illustrates the path index and Coefficient of Thermal Expansion of the monotonic gradient path deposited along a simulated part. Note that there are three distinct regions where either maximum deposition rate or maximum property gradient is the active constraint, according to Eq. 6.

FIG. 11 illustrates compositions along a planned gradient part.

FIG. 12 illustrates an exemplary computer that may comprise all or a portion of the system for determining gradient paths for compositionally graded alloys, or a control system for multi-material printers; conversely, any portion or portions of the computer illustrated in FIG. 12 may comprise all or a portion of the system for determining gradient paths for compositionally graded alloys, or a control system for multi-material printers; conversely.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Throughout this application, various publications may be referenced. The disclosures of these publications in their entireties are hereby incorporated by reference into this application in order to more fully describe the state of the art to which the methods and systems pertain.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Throughout the present disclosure, the terms “optimal,” “optimum” and “optimally” are used to refer to the results of a mathematical optimization problem. It should be understood that the mathematical optimization results described herein are not intended to be limiting, and that different optimization techniques, path planning techniques, constraints, and results are contemplated.

Compositionally graded alloys can realize multiple conflicting properties in the same part, but the formation of secondary phases can lead to cracks or deleterious properties. Computational methodologies can be used that can design compositional gradients to avoid these phases at any temperature in high dimensions. The methodology also optimizes paths for a specified cost function, but existing methodologies only consider minimizing path length or maximizing obstacle clearance.

Methods and systems are disclosed herein that implement cost functions that implement property optimization into the FGM (Functionally Graded Material) design methodology. Compositional paths with monotonic property profiles can be identified and applied to create different property profiles. Additionally, monotonic property gradients can be made to take many diverse forms on a graded part by carefully controlling deposition rate. A metric for non-monotonicity is then introduced into a cost function that is compatible with optimal path planners and finds a desired feasible path with monotonic properties. A synthetic case study is then conducted to demonstrate the effect of a cost function parameter on the balance between length and monotonicity. Additionally, a compositionally graded alloy is designed in the Fe—Co—Cr space to demonstrate the effectiveness of the methodology in finding a compositional path with a monotonic change in Coefficient of Thermal Expansion (CTE). It is then shown how this compositional gradient can be deposited subject to a maximum deposition rate and property gradient.

Specifically, monotonicity is a useful quality of a pathwise property gradient because monotonic property gradients can be transformed to many forms on the part by controlling deposition rate. The proposed cost function uses a metric for nonmonotonicity to find a desired path with monotonic properties and is compatible with different optimal path planners. A synthetic case study examines the effect of a cost function parameter on the trade-off between length and monotonicity. The cost function is also demonstrated in the Fe—Co—Cr system to find a compositional path with monotonic gradients in Coefficient of Thermal Expansion (CTE). The deposition of the path on a simulated part is then planned subject to a maximum deposition rate and CTE gradient. Multiple properties may be incorporated, and Multi-Material Topology Optimization (MMTO) techniques can be used as part of the disclosed design methodology for functionally graded metal parts.

The design of FGMs as a path planning problem has been formulated consistent with motion planning frameworks. The results of that formulation are described herein. Let Z^{d} represent the relevant composition space of the gradient, where d is the dimensionality of the space and is equal to the number of relevant elements. Let z represent a point in that space: the composition of every relevant element i at a single material point, as seen in Eqn. 1.

$$z = \{ {x}_{1} , . . . , {x}_{d} : {\sum }_{i = 1}^{d} {x}_{i} = 1 and {x}_{i} \geq 0 ∀ i \} \qquad ( 1 )$$

The subset of undesirable compositions, like those with un-desirable phases or with poor solidification properties, form the obstacle region, Z_{obs}⊂Z^{d}, that is to be avoided by the gradient path. In contrast, the complement of the obstacle region is the free space, Z_{free}=Z^{d}\Z_{obs}, which represents the viable composition space for gradient path planning.

The goal of the FGM design problem is find the optimal gradient or path in this composition space between two predefined compositions, zᵢₙᵢₜ and z_{goal}. Let the continuous function σ: [0, 1]→z represent such a path. Let α [0, 1] represent a path index that scales with distance traveled along a path (i.e. path length), 1, in state space (i.e. composition space). Equation 2 represents the scaling of α where α is defined as the path length up to a position σ (α) along the path normalized by the total length of the path.

$$α := \frac{l ( σ ( 0 ) , σ ( α ) )}{l ( σ ( 0 ) , σ ( 1 ) )} ∀ α ∈ [ 0 , 1 ] \qquad ( 2 )$$

A compositional gradient path is collision-free if it is contained entirely within free space: σ(α)∈Z_{free}∀α∈[0,1]

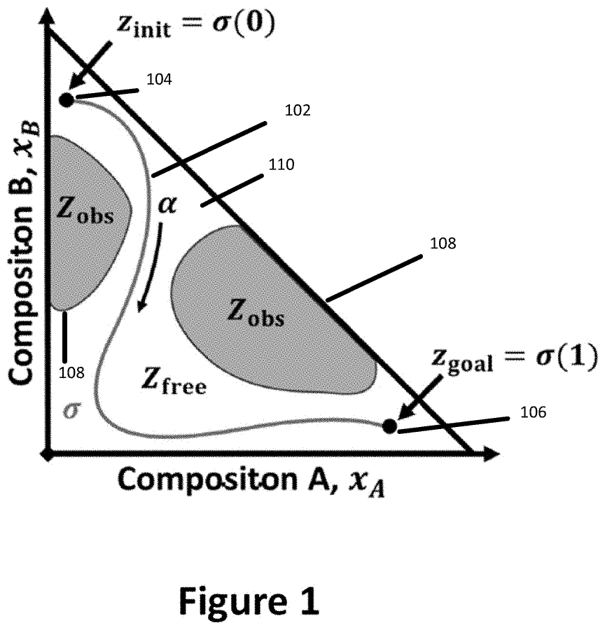

A gradient path is feasible if it is collision free, σ(0)=zᵢₙᵢₜ, and σ(1)=z_{goal}. FIG. 1 illustrates a feasible path 102 in a simplified example. The path 102 connects an initial composition (“Zinit”) 104 with a final composition (“Zgoal”) 106. The path represents a gradient of material compositions that avoids compositions that are in the obstacle regions 108. As shown in FIG. 1, the free space(s) 110 can be the complement of the obstacle region(s) 108 (i.e. the problem space can be bounded so that each composition is classified as either part of the obstacle region(s) 108 or the free space(s) 110). Different numbers of obstacle 108 and free spaces 110 are contemplated, and it is possible that there may be any number of obstacle 108 and/or free spaces 110, and that the obstacle 108 and free spaces 110 may be represented in more than two dimensions as the number of materials that are part of the composition increases. The optimal gradient path, σ_{best}, is that which is feasible and also minimizes the cost function c: σ→R_{≥0}. The cost function (e.g. path length) is defined by the designer but can be strictly positive. To be strictly positive, the cost function can equal zero if σ(α)=σ(0); ∀α∈[0,1]. The FGM design problem is summarized in the problem formulation below.

$$Find {σ}_{best} = {arg min}_{σ} c ( σ )$$

$$subject to σ ( α ) ∈ {Z}_{free} ∀ α ∈ [ 0 , 1 ] , \\ σ ( 0 ) = {z}_{init} , \\ σ ( 1 ) = {z}_{goal} .$$

A computational FGM design methodology, can encode some of these design principles computationally. In short, the methodology can build a surrogate model of phase regions from CALPHAD software and then use a path planning algorithm to design paths that avoid undesirable phase regions while optimizing a specified cost function. As a computational methodology, it escapes the limitations of human visualization and enables the design of gradient paths in high dimensional spaces. It can avoid undesirable phase regions and even optimize gradient paths for cost functions like path length or obstacle clearance. The methodology can design a nonlinear compositional gradient in the Fe—Ni— Cr space that avoids the deleterious sigma and CrNi2 phases at all relevant temperatures. For example, in Eliseeva, O. V., Kirk, T., Samimi, P., Malak, R., Arroyave, R., Elwany, A., and Karaman, I., 2019. “Functionally Graded Materials through robotics-inspired path planning”. Materials & Design, 182, November, p. 107975 provides an example of how this gradient can be printed, which is hereby incorporated by reference in its entirety. As described by Eliseeva, this gradient was printed and, even with some compositional error during printing, shown to produce less deleterious phases compared to the linear gradient.

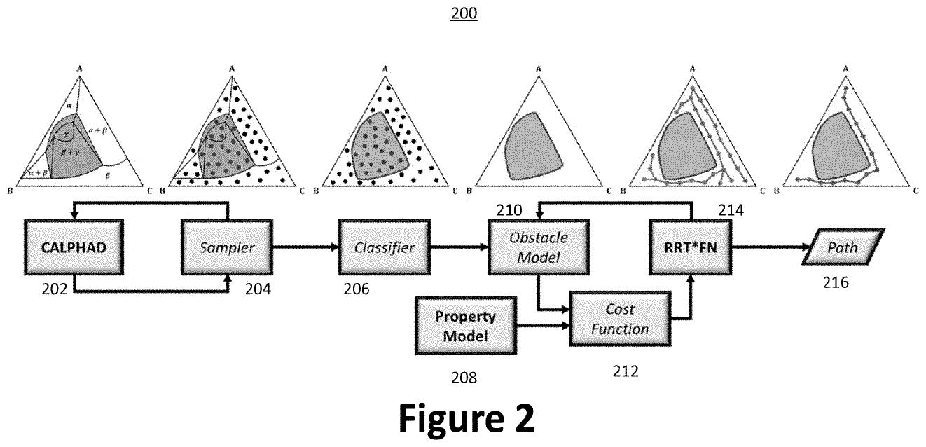

FIG. 2 illustrates a method 200 for performing computational design of compositionally graded alloys, according to one embodiment of the present disclosure.

A thermodynamic model 202 can be used to generate a configuration space. The configuration space can include processing characteristics and/or microstructure characteristics. A non-limiting example of a thermodynamic model 202 that can be used is the CALculation of PHAse Diagram (CALPHAD) as shown in FIG. 1. A CALPHAD model can be used to predict the equilibrium phases present at a fixed thermodynamic state (i.e. composition and temperature). These predictions can be used to create an obstacle model or, in other words, a model of the locations of one or more undesirable material characteristics (e.g. material phases) in composition space. CALPHAD can be sampled iteratively during the path planning process, however path planning algorithms can require millions of samples of the obstacle model to plan an optimal path. As such, the execution time of the obstacle model is of importance to the overall execution time of the path planning process. By using CALPHAD samples to build a surrogate obstacle model, the computational expense of the obstacle model can be reduced by several orders of magnitude.

The CALPHAD model can be sampled by a sampler 204 to build the surrogate obstacle model. A sampler 204 can use pseudo-random space-filling sampling (e.g. a Halton sequence sampling) of CALPHAD 202 in the relevant composition space. Alternatively or additionally, the sampler 204 can select locations in a regular grid within the configuration space. The sampled compositions are then labeled as belonging to the obstacle region (e.g. those containing undesirable phases) or the free region. The compositions that have been labeled and sampled are classified by the classifier 206. In some embodiments of the present disclosure the classifier 206 can be a machine learning classification algorithm. The classifier 206 can create the surrogate obstacle model 210. Non-limiting examples of classifiers that can be used in embodiments of the present disclosure include k-nearest neighbors classifiers, a support vector machine classifiers, a support vector data descriptions, and/or artificial neural networks. Non-limiting examples of properties that the samples of the thermodynamic model 202 can represent include: coefficient of thermal expansion, thermal conductivity, electrical conductivity, density, strength, ductility, hardness, stiffness, transformation stress, transformation strain, magnetization, coercivity, magnetic susceptibility, material phase, and combinations of these properties that represent material performance indices.

In addition to the obstacle model 210, a property model 208 can be used if the cost function 212 is a function of properties. Non-limiting examples of properties that can be used include coefficient of thermal expansion, thermal conductivity, electrical conductivity, density, strength, ductility, hardness, stiffness, transformation stress, transformation strain, magnetization, coercivity, magnetic susceptibility, material phase, and combinations of these properties that represent material performance indices. For example, a cost function 212 is disclosed that prioritizes monotonic property profiles along a gradient path, and a property model 208 can be used to predict these profiles. Another non-limiting example of a cost function 212 that can be used in embodiments of the present disclosure is a path length objective. Suitable property models 208 can be valid for the entire relevant composition space or at the free region, Z_{free}. Some models are valid for wide ranges of compositions like those for thermodynamic properties included in many CALPHAD databases.

A path planning method 214 can be applied to the obstacle model 210 and the cost function 212 to generate a path 216. The cost function 212 can be a function of different metrics. Non-limiting examples of cost functions 212 that can be used include path length, distance from obstacles, and property gradients.

Different path planning methods 214 can be used for solving FGM design problems in embodiments of the present disclosure directed to FGM design problems. Some embodiments of the present disclosure use sampling-based path planning methods 214, which are adaptable to a variety of cost functions, scalable to high dimensions, and can be easy to implement. As a non-limiting example, implementations of RRT* can be used in embodiments of the present disclosure described herein as a path planning method 214. Karaman, S., and Frazzoli, E., 2011. “Sampling-based algorithms for optimal motion planning” in the International Journal of Robotics Research, 30(7), pp. 846-894 provides an example of an implementation of RRT*, hereby incorporated by reference in its entirety. RRT* can be an asymptotically optimal version of the Rapidly-exploring Random Tree algorithm. Alternatively or additionally, the sampling based planner can be a fixed nodes implementation of RRT* (RRT*FN) can be used as a path planning method 214 in some embodiments of the present disclosure. RRT*FN that can limit the maximum number of nodes in a tree and therefore limits the occupied computer memory. RRT*FN can iteratively sample an environment and create a tree of paths in free space, Z_{free}. New samples can be connected to a parent node in the tree so that the path 216 formed minimizes the cost function, provided the connection would not collide with the obstacle region, Z_{obs}. Surrounding nodes are evaluated to determine if their paths would be cheaper with the new sample as their parent node and corresponding connections are rewired. Given enough random samples, RRT* can find a feasible path 216 if one exists (i.e. probabilistic completeness). Also, the optimal path 216 in the tree approaches the globally optimal path as the number of samples increases (i.e. asymptotic optimality). RRT*FN and RTT* are intended only as non-limiting examples of path planning methods 214 that can be used in conjunction with the obstacle model, and the use of other path planning methods 214 is contemplated by the present disclosure. For example, other path planning algorithms may be used such as an incremental search, a heuristic search, an incremental heuristic search, a grid-based search, an interval-based search, a sampling-based search, A*, D*, rapidly-exploring random tree, probabilistic roadmap, or any other appropriate path planning algorithm may be used.

When an optimal sampling-based path planning method 214 (e.g. PRM*, RRT*, RRT*FN) is asymptotically optimal, cost functions 212 can be strictly positive, monotonic and bounded. To be strictly positive the cost of a path 214 can be zero if the path never moves from its starting position (i.e. c(σ)=0 if and only if σ(α)=σ(0), α[0, 1]). A monotonic cost function 212 satisfies the condition c(σ1)≤c(σ1|σ2) for all σ1, σ2∈Σ, where σ1|σ2 represents the concatenation of paths. The concatenation of paths is an operation performed on paths σ₁, σ₂∈Σ where σ₁(1)=σ₂(0). The concatenated path is defined by Eqn. 3:

$$( {σ}_{1} \vert {σ}_{2} ) ( α ) := \{ \begin{matrix}{σ}_{1} ( \frac{α}{c} ) & ∀ α ∈ [ 0 , c ] \\ {σ}_{2} ( \frac{α - c}{1 - c} ) & ∀ α ∈ [ c , 1 ]\end{matrix} \qquad ( 3 )$$

Where

$$c = \frac{l σ 1}{l σ 1 + l σ 2}$$

is the ratio between the length of the path σ₁ and the combined lengths of paths σ₁ and σ₂.

Functionally Graded Materials can be desirable for the gradients they produce in properties and therefore function. As such, the consideration of properties can be a component of FGM design. Even properties that are not directly relevant to performance can be relevant to manufacturability and part integrity. One such property is the Coefficient of Thermal Expansion (CTE), which often varies dramatically with composition in alloys. Large discontinuities in CTE can be present at phase boundaries in gradient materials. During the high-temperature additive manufacturing process, FGMs experience large thermal gradients. Consequently, these discontinuities in CTE often lead to cracking during manufacturing.

The compositional path that minimizes the stresses induced by property gradients is one that minimizes the property gradients themselves. Let y represent the length in physical space along a gradient part and p(z) represent some property of interest that is a function of material composition (e.g. CTE). If the local change in the property p along the physical part,

$$\frac{dp}{d y} ,$$

is too large, then significant stress gradients can form. Therefore, the gradient path that minimizes property-induced stresses can be the gradient path that minimizes

$$\frac{dp}{d y}$$

The maximum property gradient

$$\frac{dp}{d y}$$

along a part is minimized when the property is graded linearly along the part and

$$\frac{dp}{d y}$$

is constant everywhere. However, there may not be a compositional gradient path σ(α) for which an arbitrary property varies linearly as a function of path index α.

Fortunately, the rate at which the compositional gradient is deposited on the physical part can be an accessible design parameter that can be varied during the build. Controlling this deposition rate,

$$\frac{dα}{dy} ,$$

call allow designers to vary properties linearly along the dimensions of the part even if the property does not vary linearly with composition or path index. For example, due to the relationship shown in Eqn. 4, one can achieve a constant

$$\frac{dp}{d y}$$

by adjusting

$$\frac{d α}{d y}$$

as α increases from 0 to 1. The rate at which the composition is changed for each material in the functionally graded material can be based on an optimal gradient path through the composition space. Similarly, the deposition rate can be varied to create a functionally graded material with a desired property profile, based on the gradient path.

$$\frac{dp}{dy} = \frac{dp}{dα} ( \frac{dα}{dy} ) \qquad ( 4 )$$

This can be possible if the condition shown in Eqn. 5 is true, where Δpₜₒₜₐₗ=p(z_{goal})−p(zᵢₙᵢₜ).

$$sgn ( \frac{dp}{dα} ) = sgn ( Δ {p}_{total} ) ∀ α ∈ [ 0 , 1 ] \qquad ( 5 )$$

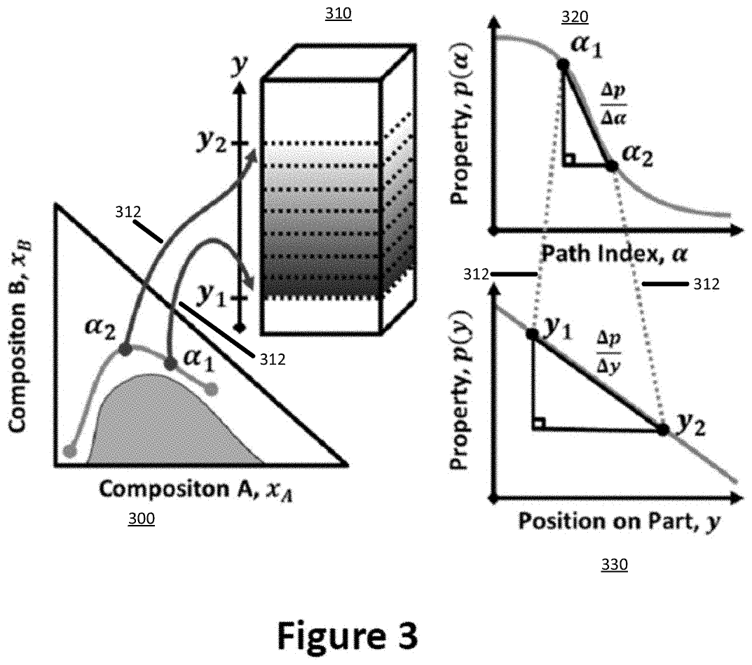

This condition indicates that properties vary monotonically along the compositional gradient path, meaning they either always decrease or always increase with path index, a. It also suggests that any property that is monotonic with path index can be mapped into a linear property gradient on the physical part by controlling material deposition rate, subject to the maximum and minimum achievable deposition rates. This process is depicted visually in FIG. 3.

Navigating the determined path through composition space (e.g. the composition space illustrated in FIG. 1) to provide the desired property may result in non-linear changes to the property over the composition space path. In order to have a part exhibit a linear property profile across the length of the part, the deposition rate for the material(s) may be modified. Varying the deposition rate can also be used to create desired non-linear or non-monotonic part characteristics.

FIG. 3 illustrates relationships between composition space 300, a part 310, a graph 320 of property as a function of path index, and a graph 330 of property and position (e.g. y₁ and y₂) on the part 310. As described herein, it can be desirable to have properties vary linearly between two positions on a part. When the graph 320 of property index vs. path index is monotonic (i.e. always increasing or decreasing) it is possible to change the rate of deposition along the part 310 to achieve a linear relationship between a property and the position on the part as shown in the graph 330. This can be used in two and three dimensional parts 310 to create desirable property gradients. The relationship between the path index α in composition space 300 and the position on part (y) in a physical part 310 is also illustrated by arrows 312 connecting points in composition space 300 with physical locations on the part 310 that include those compositions. Similarly, graphs 320 330 are linked by arrows 322 that show how a non-linear graph 320 of property vs. path index can be manufactured to create a part with a linear relationship between properties and their positions on the parts.

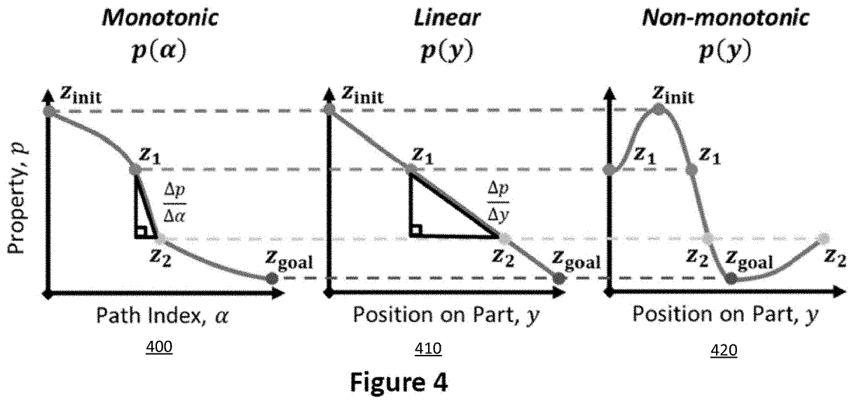

FIG. 4 illustrates how a monotonic relationship between property and path index, can also be used to create both monotonic and non-monotonic property profiles. Graph 400 illustrates a monotonic relationship between a property and path index. Graph 410 illustrates how the monotonic relationship between a property and path index can be transformed into a monotonic and linear relationship between a property and a physical position on a part (e.g. the part 310 illustrated in FIG. 3). Finally, graph 420 illustrates how the monotonic relationship between property and path index shown in graph 400 can be also used to create a non-monotonic relationship between a property and position on a part. The present disclosure contemplates that the final relationship between property and position on a part can be any combination of linear, non-linear, monotonic, and non-monotonic, and the illustrations shown in FIGS. 3 and 4 are intended only as non-limiting examples of how embodiments of the present disclosure can be used to design parts with different characteristics.

Pathwise property profiles, p(α), that are monotonic with path index can also be mapped into any partwise property profile, p(y), that is monotonic with y. Furthermore, as illustrated in FIG. 4, pathwise property profiles that are monotonic with path index can even be transformed to vary non-monotonically along a part, given that the non-monotonic part profile is still bounded by the property values at zᵢₙᵢₜ and z_{goal}. This capability means that a pathwise property profile, p(α), that is monotonic with path index can be mapped into a properly bounded partwise profile, p(y), subject to machine deposition rates. To determine the appropriate machine deposition rates for a desired partwise property profile, one can manipulate the relationship shown in Eqn. 4.

In practice, p(y) can be designed such that practical constraints on the maximum property gradient

$$\vert \frac{dp}{d y} \vert$$

and a maximum deposition rate

$$\vert \frac{d α}{d y} \vert$$

are satisfied. In that case, Eqn. 6 provides a method for calculating dy, where dy is evaluated at every point in the path. This dy can then be used to determine how many layers in the part need to be dedicated to each portion of the path.

$$dy = max \{ dp {\vert \frac{dp}{dy} \vert}_{max}^{- 1} , dα {\vert \frac{dα}{dy} \vert}_{max}^{- 1} \} \qquad ( 6 )$$

Gradient paths with monotonic property profiles can be mapped onto a part with practically any partwise property profile a designer might desire, subject to machine limitations. Consequently, a feasible compositional gradient path with a monotonic property profile can be desirable in certain design situations. Therefore, to find compositional gradient paths that will provide a desired partwise property profile, embodiments of the present disclosure can find paths with properties that vary monotonically with part index.

To introduce the ability to find gradient paths with monotonic properties into the FGM design methodology, a cost function that prioritizes such paths can be used. A non-limiting example of a cost function for finding gradient paths with monotonic properties is the Lack of Monotonicity (LOM) metric. LOM relies on the calculation of two additional quantities: Lack of Increase (LOI) and Lack of Decrease (LOD). To calculate the Lack of Increase of a general continuous function g₀ over the interval [a, b] one can integrate the negative part of the first derivative of g₀ over the Lebesgue measure, λ, as seen in Eqn. 7 where g₀′=max{−g₀′, 0}. Note that if g₀ is monotonically increasing over the interval [a, b], then LOI[a,b](g₀)=0.

LOI_{[a,b]}(g₀)=∫ₐ^{b}(g′₀)⁻dλ (7)

Lack of Decrease is calculated similarly by integrating the positive part of the first derivative of g0, as seen in Eqn. 8 where (g₀′)⁺=max{−g₀′, 0}.

LOD_{[a,b]}(g₀)=∫ₐ^{b}(g′₀)⁺dλ (8)

Finally, the Lack of Monotonicity of g0 over the interval [a, b] is shown in Eqn. 9.

LOM_{[a,b]}(g₀)=2 min{LOI_{[a,b]}(g₀),LOD_{[a,b]}(g₀)} (9)

These metrics can be used to assess the lack of monotonicity in a pathwise property profile and consequently can be used in the FGM design methodology to identify gradient paths with monotonic properties. The LOI and LOD of the property profile, p(α), for a given path, σ, can be calculated from Eqns. 10 and 11 respectively.

$$\begin{matrix}{LOI}_{σ} ( p ) = {\int }_{0}^{1} {( \frac{dp}{dα} )}^{-} dα & ( 10 ) \\ {LOD}_{σ} ( p ) = {\int }_{0}^{1} {( \frac{dp}{dα} )}^{+} dα & ( 11 )\end{matrix}$$

To implement these metrics into the current methodology they can be formulated into a compatible cost function 212. RRT*FN and many other tree- or map-based planners 216 store segment costs independently and then sum the costs of each segment in a path to compute the total path cost. For example, Adiyatov, O., and Varol, H., 2013. “Rapidly-exploring random tree based memory efficient motion planning”. In Mechatronics and Automation (ICMA), 2013 IEEE International Conference on, pp. 354-359 provides an example of RRT*FN, which is hereby incorporated by reference in its entirety. As such, a compatible cost function can be additive, satisfying the condition that c(σ₁σ₂)=c(σ₁)+c(σ₂) for all σ₁, σ₂∈Σ. This condition can be incompatible with LOM because, as shown in Eqn. 9, LOI and LOD can be evaluated for the total path before selecting which is the minimum quantity. For example, a path σ1 with strictly increasing properties would have LOM σ₁=0 and a path σ₂ with strictly decreasing properties would have LOMσ2=0, but their concatenated path would have LOM(σ₁σ₂)≠0.

To remedy this issue, the change in properties between the initial and goal compositions can be evaluated and then either LOI or LOD could be used alone in place of LOM. For example, if Δpₜₒₜₐₗ>0 (i.e. p(zᵢₙᵢₜ)<p(z_{goal})), any monotonic profile between p(zᵢₙᵢₜ) and p(z_{goal}) can be non-decreasing. In this case, LOI will measure the deviation from a monotonic property profile because all monotonic profiles can be non-decreasing (i.e. LOI=0), while all non-monotonic profiles can increase somewhere (i.e. LOI>0). Similarly, if Δpₜₒₜₐₗ>0 (i.e. p(zᵢₙᵢₜ)>p(z_{goal})), LOD will measure the deviation from all monotonic profiles, which are all non-increasing.

In order for a cost function to ensure asymptotic optimality with an optimal sampling-based planner like PRM*, RRT*, or RRT*FN it can be strictly positive, monotonic, and bounded. Both LOI and LOD are bounded ∫ₐ^{b}|g0′|dλ, and monotonic for concatenated paths, but neither are strictly positive. This is because LOI_{σ}(p)=0 and LOD_{σ}(p)=0 for non-decreasing and non-increasing property profiles respectively.

### Example 1

Disclosed herein are non-limiting examples of using embodiments of the present disclosure to design functionally graded materials. An embodiment of the method 200 shown in FIG. 2 was configured to generate property models. By including path length (i.e. the Euclidean distance traversed by the path in composition space) into the cost function 212 with LOI or LOD, shorter monotonic paths 216 can become preferred to longer ones. Also, the cost function 212 itself becomes strictly positive as path length is strictly positive and both LOI and LOD are non-negative. Designers can diminish the effect of path 216 length in the cost function 212 by introducing a weighting parameter, w, with very low magnitude. Such a parameter could effectively ensure path length is an active objective only when LOI or LOD are zero. A study on the magnitude of this parameter is presented later in this work.

Equation 12 presents a cost function that can satisfy the aforementioned criteria. As such, it can be easily implemented into the current methodology to obtain gradient paths with monotonic property profiles.

$$c ( σ ) = \{ \begin{matrix}{LOI}_{σ} ( p ) + wl & if Δ {p}_{total} > 0 \\ {LOD}_{σ} ( p ) + wl & if Δ {p}_{total} < 0\end{matrix} \qquad ( 12 )$$

The cost function shown in Eq. 12 was designed to seek the shortest gradient path with a monotonic property profile. A simple synthetic case study was created to test the ability of the cost function to find such paths. The case study was also used to examine the effect of the parameter w on the cost function's tendency to balance length and lack of monotonicity.

An artificial property model was generated for a two-dimensional input space, x1, x2∈[0, 1]. The property model was created to have non-monotonic regions, but still enable monotonic paths from zᵢₙᵢₜ=(1, 1) to z_{goal}=(0, 0). This model, p(x1, x2), was created from an initial planar surface rotated along the line x₁+x₂=1 to be monotonic with both x₁ and x₂. A non-monotonic region was created on the planar surface by modelling a semi-ellipsoid on the surface of the plane that was oriented normal to the plane with a major axis parallel to the line x1+x2=1. The semi-ellipsoid was sized to be small enough to allow for monotonic paths from zᵢₙᵢₜ=(1, 1) to z_{goal}=(0, 0), but large enough to make the straight-line, shortest length path non-monotonic. The final model has values ranging from approximately 0.3 to 0.7 for x1, x2∈[0, 1].

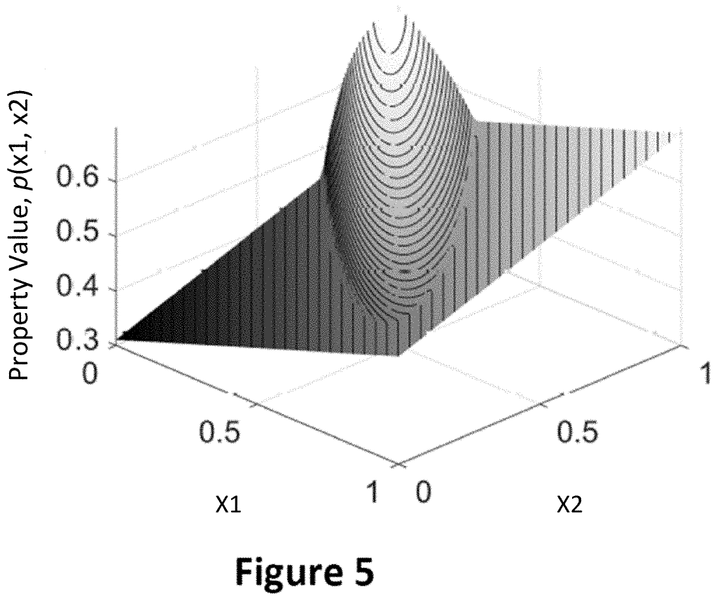

FIG. 5 illustrates the surface of the synthetic property model. To test the cost function presented in Eq. 12, the path planning algorithm, RRT*FN 214, was used to plan several paths 216 in x₁ and x2 from zᵢₙᵢₜ=(1, 1) to z_{goal}=(0, 0). In this example, an obstacle region was not considered. Because the synthetic property model has a lower value at z_{goal} than zᵢₙᵢₜ, Lack of Decrease (LOD) was used to measure non-monotonicity. Each of the seven runs of the path planning algorithm used a different value of the parameter w in the cost function, increasing in magnitude from 10⁻⁶ to 1. As such, each run had a different weighting between lack of decrease and path length. Each run of RRT*FN 214 generated 5000 random samples with the same random seed, meaning each run used the same points to generate a tree and find an optimal path.

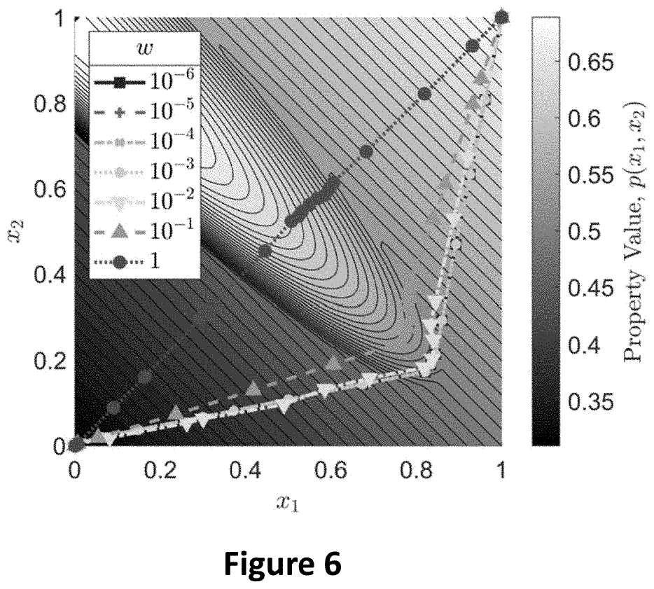

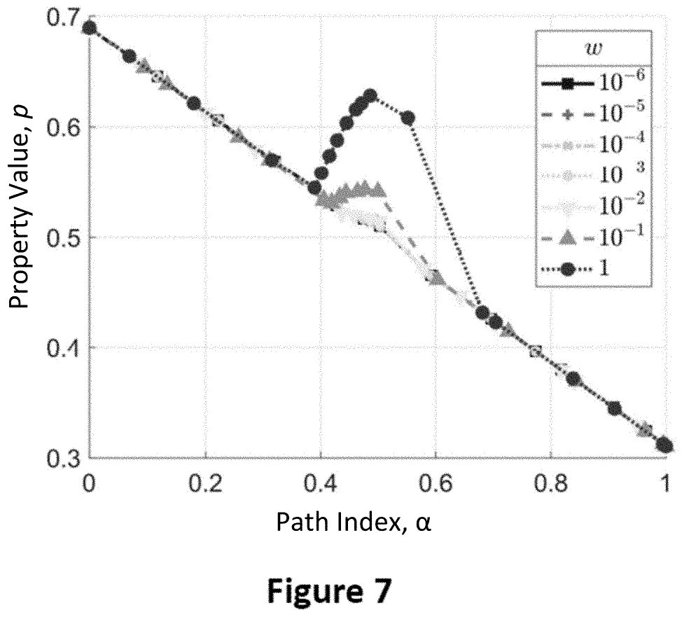

The paths planned by each run of RRT*FN 214 are shown in FIG. 6 and their respective pathwise property profiles are shown in FIG. 7. The values of each term in the cost function for the optimal paths in each run are listed in Table 1. When the weighting parameter is very small (w≤10⁻³), the cost function seems to perform as intended and prioritize monotonicity before path length. In fact, the paths produced when w=10⁻⁶, 10⁻⁵, 10⁻⁴, and 10⁻³ are exactly the same and resemble the desired path: the shortest monotonic path between zᵢₙᵢₜ and z_{goal}. As w increases to 10⁻² and 10⁻¹, the paths become slightly shorter by encroaching into the ellipsoidal region, but also produce non-monotonic property profiles (LOD_{σ}(p)>0). When w is further increased to 1, the length term in the cost function completely dominates and the path produced is the straight-line shortest length path between zᵢₙᵢₜ and z_{goal}.

In practice, w can be set as low as possible to make minimizing length a secondary objective to promoting monotonicity.

These results indicate that a value of w=10⁻³ can produce the desired behavior for similarly scaled problems. All composition spaces are bounded by 0 and 1, so some FGM design problems can be of similar scale if the property model is scaled to have bounds near 0 and 1.

TABLE 1
Values of cost function terms for optimal paths
in synthetic case study

| w | l | LOD_{σ}(p) | c(σ)(Eqn. 12) |
|---|---|---|---|
| 10⁻⁶ | 1.6882 | 0 | 1.6882 × 10⁻⁶ |
| 10⁻⁵ | 1.6882 | 0 | 1.6882 × 10⁻⁵ |
| 10⁻⁴ | 1.6882 | 0 | 1.6882 × 10⁻⁴ |
| 10⁻³ | 1.6882 | 0 | 1.6882 × 10⁻³ |
| 10⁻² | 1.6841 | 1.6223 × 10⁻⁵ | 1.6857 × 10⁻² |
| 10⁻¹ | 1.5995 | 6.3248 × 10⁻³ | 1.6627 × 10⁻¹ |
| 1 | 1.4164 | 4.4215 × 10⁻² | 1.4606 |

### Example 2

Described below is a non-limiting example and case study examining the performance of an embodiment of the present disclosure as applied to a realistic FGM design problem. As a non-limiting example, an embodiment of the method 200 shown in FIG. 2 was used to design a compositionally graded alloy with a monotonic gradient in Coefficient of Thermal Expansion (CTE). Steep gradients in CTE can lead to detrimental stress gradients during the additive manufacturing process and are therefore relevant to the design of compositionally graded alloys.

The iron-cobalt-chromium (Fe—Co—Cr) ternary system was chosen for this case study because it is easily visualized in two dimensions and has significant relevance to many engineering materials. The end points of the designed gradient path 216, zᵢₙᵢₜ and z_{goal}, were chosen to be Fe95Co5 [at %] and Fe10Co60Cr30 [at %], respectively. The initial point, Fe95Co5 [at %], is representative of many steels including high speed steels used in cutting tools for their high temperature resistance and hardness. The goal point, Fe10Co60Cr30 [at %], represents cobalt-chrome alloys which exhibit exceptional corrosion, wear and thermal resistance as well as high specific strength and are often used in biomedical applications. A gradient between these two materials could be employed in a surgical device or a device with significant thermal requirements like a drill or turbine.

To apply an embodiment of the present disclosure including an FGM design methodology 200 to this system, phase regions were first modeled with CALPHAD 202 software, specifically Thermo-Calc's TCHEA2 database. The CALPHAD model was sampled by the sampler 204 1275 times in a regular grid through-out the Fe—Co—Cr composition space. Phase equilibria were calculated at a temperature of 1000 K, which was chosen to approximate the temperature of the manufacturing process. Sigma (σ) phase was chosen as an undesirable phase due to its detrimental mechanical properties under certain conditions including high brittleness. A surrogate obstacle model 210 was created by labeling the samples with greater than one percent mole fraction of sigma phase and then training a k-nearest neighbors (k=3) classifier 206 to represent the sigma phase region.

Thermo-Calc's TCHEA2 can also predict Coefficients of Thermal Expansion (CTE) for any composition in its database. This capability was leveraged to make predictions of CTE at 1000 K at the same 1275 compositions that were sampled for phase information. The CTE data was made to lie within 1×10⁻⁶K⁻¹ and 1×10⁻⁴K⁻¹ by rounding outlying data to the bounds and was then scaled to range from 0 to 1. An interpolant model was then created from the data that linearly interpolates between the data to predict CTE at any composition in the Fe—Co—Cr composition space.

Given a model 210 of the obstacle region and a model 208 of the relevant property, the path planning algorithm, RRT*FN 214, was used to plan paths for two different cost functions 212. The first cost function was simply path length and was planned to assess the properties of a path planned without any consideration of optimal properties. The second cost function was that proposed in Eqn. 12, which seeks to find the shortest path with monotonic properties. Because the CTE at zᵢₙᵢₜ is greater than that at z_{goal}, LOD_{σ}(p) was chosen to measure non-monotonicity. As in the synthetic case study, the random seed was fixed for both cases so the same 5000 nodes were used to construct the tree and find the optimal path.

The path 216 can be used to create or configure instructions for a multi-material metal printer. The multi-material metal printer can use the instructions based on the path 216 to adjust the composition of an alloy as the alloy is deposited and to create an alloy that avoids compositions that fall within obstacle regions that represent undesirable compositions. For example, a multi material metal printer can fabricate a part that transitions from one composition from another without including certain compositions (i.e. those compositions represented as obstacle regions 108), as shown in FIG. 1. Non-limiting examples of multi material metal printers that can implement embodiments of the present disclosure include multi-material directed energy deposition printers, a multi-material laser/E-beam powder bed fusion printers, or a multi-material extrusion and/or sintering systems. Furthermore, the method 200 can also include modifying the deposition rate of the multi-material metal printer based on the path 216 generated by the method 200. The deposition rate and path 216 can be used by a multi-material metal printer to generate 3d printed metal parts that are made of alloys that change composition throughout the shape of the part. By using the methods described herein, the 3d printed metal parts can transition between different compositions without including undesirable compositions, and/or transition between different compositions such that intermediate compositions include desirable properties or combinations of properties. While an example of multi-material metal printers is provided in the present disclosure, other multi-material printers may be used.

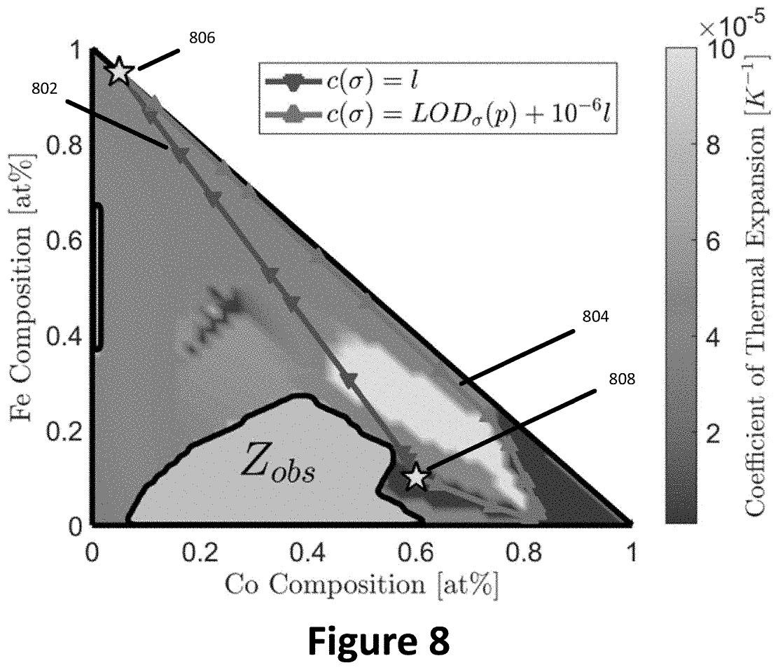

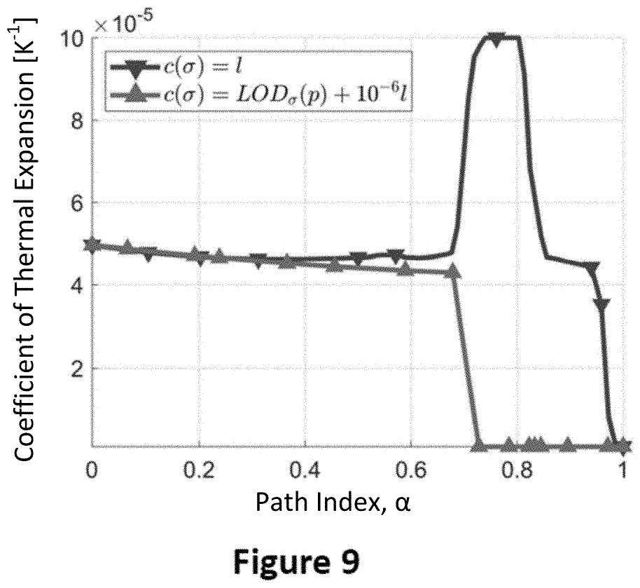

The paths 802 804 found to optimize each of the cost functions 212 are displayed in FIG. 8 and the value of CTE along each path is shown in FIG. 9. The path planned for the first cost function 802, c(σ)=1, resembles the straight-line path between zᵢₙᵢₜ 806 and z_{goal} 808. While this is the shortest feasible path 802, it experiences a large increase in CTE as it approaches z_{goal} 808, as seen in FIG. 9. This makes the property profile significantly non-monotonic. The second cost function produces the shortest path with a monotonic CTE profile 804.

While the path planned with the proposed cost function is monotonic, FIG. 9 shows a sharp decrease in CTE. However, the shortest length path also experiences a similar drop in CTE. In fact, by examining the CTE contours in FIG. 8, it appears that such a drop may be likely unavoidable as the feasible paths to z_{goal} would experience a steep decrease in CTE. In some embodiments of the present disclosure these steep regions can be mitigated by decreasing the deposition rate in these regions. Although the first path 802 is shorter, it has more steep changes in CTE and can use more layers to print due to using requiring a decrease in deposition rates in steep regions. In addition to potentially requiring less layers to print, a part made with the monotonic compositional gradient can be made to have nearly any properly bounded CTE profile, subject to machine limitations on deposition rate, as shown in FIG. 4.

To demonstrate how one could determine deposition rates, the deposition of the monotonic path was planned for a hypothetical part. While the path could be deposited so that the partwise property, p(y), was linear, it can require extreme differences in the deposition rates because of the differences in

$$\frac{dp}{d α}$$

between the steep drop in CTE and the comparatively flat regions at the beginning and end of the path, as seen in FIG. 9. This would lead to a relatively large region of the part dedicated to a small portion of the compositional gradient.

Instead, reasonable constraints for the partwise property gradient and deposition rate were used to determine the deposition plan. The position on the part, y, was measured in build layers for simplicity. As a non-limiting example, the maximum property gradient on the part,

$$\vert \frac{dp}{d y} \vert$$

was chosen to be 4 10⁻⁷ K⁻¹ per layer. The achievable change in composition per layer was estimated to be 1 at. %. This number was then divided by the total length of the path to estimate a maximum deposition rate

$$\vert \frac{d α}{d y} \vert$$

These two constraints were then used with Eqn. 6 to determine how many layers should be used to print each segment of the path.

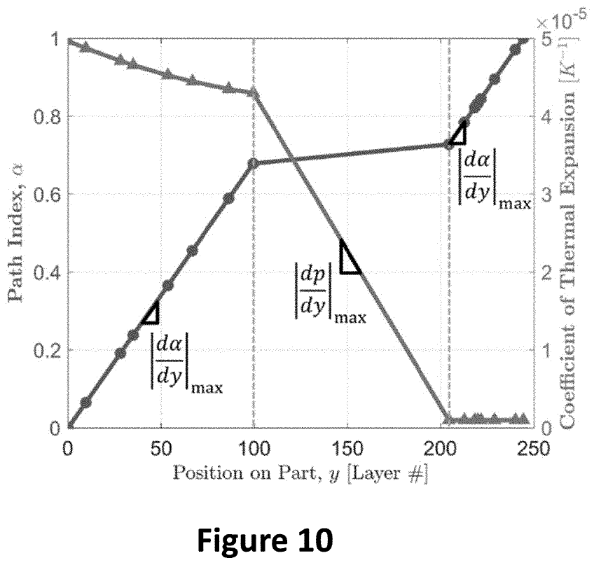

FIG. 10 illustrates the resulting gradients of path index, α, and CTE along a planned gradient part. Note that in the example illustrated in FIG. 10, there are three distinct regions where a different constraint was active. In the first part of the gradient, where

$$\frac{dp}{dα}$$

is small, the deposition rate is at its maximum. This is where the gradient is deposited as fast as possible because the associated property gradient

$$\frac{d p}{d y}$$

is insignificant. Once the steep decline in CTE is reached, the deposition rate is slowed for about 100 layers so that the property gradient is at its maximum acceptable value selected for this demonstration,

$$\vert \frac{d p}{d α} \vert$$

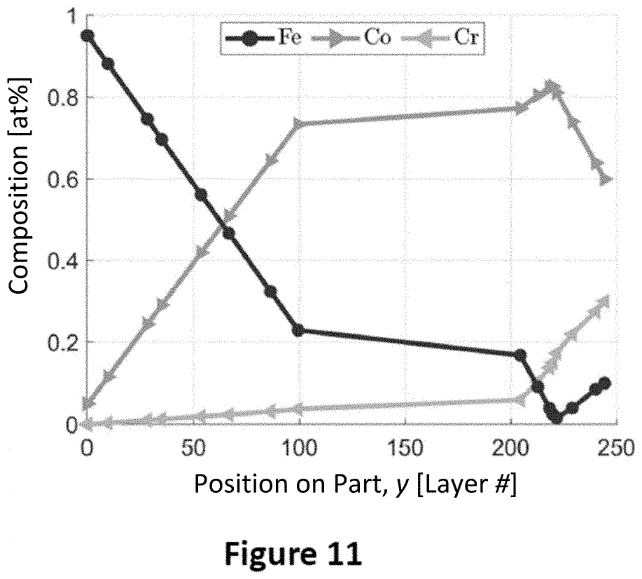

After the steep change in CTE has been navigated, the deposition rate is once again maximized. The compositions of the corresponding part are shown in FIG. 11. From layers 100 to 200, where deposition rate is slowest, the compositions barely change. This can diminish the effects of the steep property gradient,

$$\frac{dp}{d α} ,$$

seen in FIG. 9.

Embodiments of the present disclosure implement a cost function and computational design methodology that optimizes compositional gradients for their properties.

By controlling material deposition rate, compositional paths with monotonic property profiles can be made into gradient parts with nearly any properly bounded linear, monotonic, or even non-monotonic property gradient. As such, paths with monotonic property profiles can have similar value and are preferred to those with non-monotonic properties. A metric was introduced that quantifies the non-monotonicity of functions. This metric was then introduced into a cost function that is compatible with optimal path planning algorithms and finds the shortest compositional path with a monotonic property profile. A parametric study was conducted to investigate the balance between length and non-monotonicity in this cost function.

The cost function was used to design a compositional path in the Fe—Co—Cr system that has a monotonic gradient in Coefficient of Thermal Expansion (CTE). This path was compared to the shortest length path which exhibited non-monotonic properties. The deposition of the monotonic compositional gradient on a hypothetical part was planned to satisfy a specified maximum deposition rate and maximum property gradient. While the present disclosure illustrates three-element paths that are visualized in three-dimensional space, it is contemplated that different numbers of elements can be used, and that the corresponding paths can be plotted in different dimensions. For example, embodiments of the present disclosure can be extended to more than three dimensions and represent more than three elements. FGMs can be used for their ability to achieve incompatible performance objectives that a single monolithic material could not. Designing gradients for multiple properties is also contemplated by the present disclosure. Additionally, it is contemplated by the present disclosure that the compositional gradient can be planned along more than one dimension of a part. In some embodiments of the present disclosure, the deposition of a designed compositional gradient can be planned along one dimension of a gradient part. But gradient parts can require property gradients in more than one dimension. Embodiments of the present disclosure can use Multi-Material Topology Optimization (MMTO) to optimize part topology and gradient material distribution simultaneously. These methods can be applied to linear gradients in composite or polymer materials that have relatively simple and continuous property profiles. Because the property gradients produced by the proposed cost function can be monotonic, these methods can be adapted to optimize material distribution in compositionally graded metal parts by using path index as a design variable instead of volume fraction. Embodiments of the present disclosure can apply MMTO techniques to enable a full material-to-part design process for functionally graded metal parts.

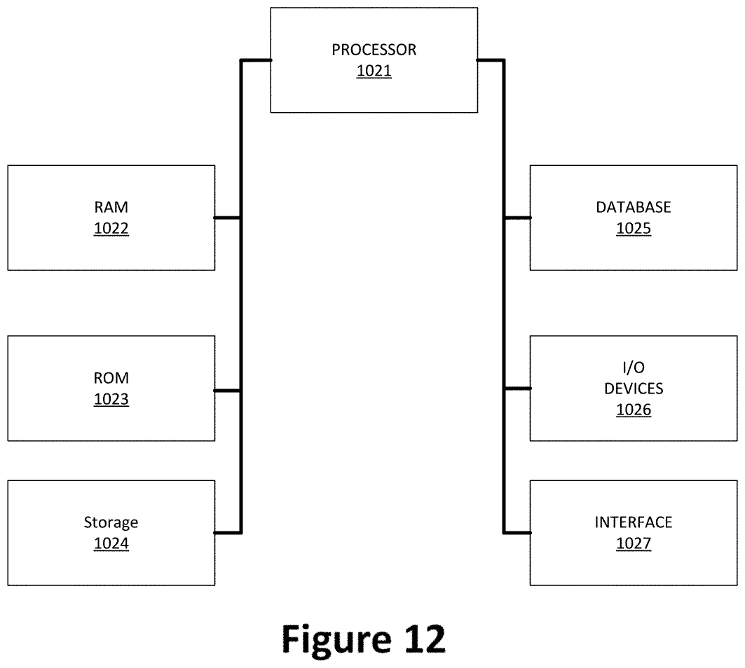

FIG. 12 illustrates an exemplary computer that may comprise all or a portion of an automated design tool for compositionally graded alloys. Conversely, any portion or portions of the computer illustrated in FIG. 12 may comprise all or part of the automated design tool for compositionally graded alloys. As used herein, “computer” may include a plurality of computers. The computers may include one or more hardware components such as, for example, a processor 1021, a random-access memory (RAM) module 1022, a read-only memory (ROM) module 1023, a storage 1024, a database 1025, one or more input/output (I/O) devices 1026, and an interface 1027. Alternatively, and/or additionally, the computer may include one or more software components such as, for example, a computer-readable medium including computer executable instructions for performing a method associated with the exemplary embodiments such as, for example, an algorithm for determining a property profile gradient. It is contemplated that one or more of the hardware components listed above may be implemented using software. For example, storage 1024 may include a software partition associated with one or more other hardware components. It is understood that the components listed above are exemplary only and not intended to be limiting.

Processor 1021 may include one or more processors, each configured to execute instructions and process data to perform one or more functions associated with a computer for controlling a system (e.g., automated design tool) and/or receiving and/or processing and/or transmitting data associated with electrical sensors. Processor 1021 may be communicatively coupled to RAM 1022, ROM 1023, storage 1024, database 1025, I/O devices 1026, and interface 1027. Processor 1021 may be configured to execute sequences of computer program instructions to perform various processes. The computer program instructions may be loaded into RAM 1022 for execution by processor 1021.

RAM 1022 and ROM 1023 may each include one or more devices for storing information associated with operation of processor 1021. For example, ROM 1023 may include a memory device configured to access and store information associated with the computer, including information for identifying, initializing, and monitoring the operation of one or more components and subsystems. RAM 1022 may include a memory device for storing data associated with one or more operations of processor 1021. For example, ROM 1023 may load instructions into RAM 1022 for execution by processor 1021.

Storage 1024 may include any type of mass storage device configured to store information that processor 1021 may need to perform processes consistent with the disclosed embodiments. For example, storage 1024 may include one or more magnetic and/or optical disk devices, such as hard drives, CD-ROMs, DVD-ROMs, or any other type of mass media device.

Database 1025 may include one or more software and/or hardware components that cooperate to store, organize, sort, filter, and/or arrange data used by the computer and/or processor 1021. For example, database 1025 may store data related to the plurality of thrust coefficients. The database may also contain data and instructions associated with computer-executable instructions for controlling a system (e.g., an multi-material printer) and/or receiving and/or processing and/or transmitting data associated with a network of sensor nodes used to measure water quality. It is contemplated that database 1025 may store additional and/or different information than that listed above.

I/O devices 1026 may include one or more components configured to communicate information with a user associated with computer. For example, I/O devices may include a console with an integrated keyboard and mouse to allow a user to maintain a database of digital images, results of the analysis of the digital images, metrics, and the like. I/O devices 1026 may also include a display including a graphical user interface (GUI) for outputting information on a monitor. I/O devices 1026 may also include peripheral devices such as, for example, a printer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 1027 may include one or more components configured to transmit and receive data via a communication network, such as the Internet, a local area network, a workstation peer-to-peer network, a direct link network, a wireless network, or any other suitable communication platform. For example, interface 1027 may include one or more modulators, demodulators, multiplexers, demultiplexers, network communication devices, wireless devices, antennas, modems, radios, receivers, transmitters, transceivers, and any other type of device configured to enable data communication via a wired or wireless communication network.

The figures illustrate the architecture, functionality, and operation of possible implementations of systems, methods and computer program products according to various implementations of the present invention. In this regard, each block of a flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The implementation was chosen and described in order to best explain the principles of the invention and the practical application, and to enable others of ordinary skill in the art to understand the invention for various implementations with various modifications as are suited to the particular use contemplated.

Any combination of one or more computer readable medium(s) may be used to implement the systems and methods described hereinabove. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where α method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for determining an optimal configuration of a functionally graded material, the method comprising:
sampling a multi-dimensional configuration space with a thermodynamic model of phase stability to determine a plurality of samples within the configuration space, wherein each sample comprises phase information of a composition at a distinct location within the configuration space;
determining an obstacle model based on the plurality of samples, the obstacle model defining one or more obstacle regions in the configuration space with one or more undesirable characteristics;
determining a free space within the configuration space in which a subset of the plurality of samples within the free space represent one or more desired material characteristics;
determining a property model that is valid within the free space of the configuration space;
determining a cost function, wherein the cost function is a function of a property in the property model and comprises a lack of monotonicity objective; and
determining an optimal gradient path through the free space within the configuration space using a path planning algorithm that is configured to minimize the cost function.

2. The method of claim 1, wherein the cost function is further a function of one or more metrics computed from the configuration space selected from a group of metrics consisting of path length, distance from obstacles, and property gradients.

3. The method of claim 1, wherein the path planning algorithm is a Rapidly-exploring Random Tree algorithm.

4. The method of claim 1, wherein the obstacle model is determined using a machine learning classifier.

5. The method of claim 4, wherein the machine learning classifier is selected from a group of machine learning classifiers consisting of: a k-nearest neighbors classifier, a support vector machine classifier, a support vector data description, or an artificial neural network.

6. The method of claim 1, wherein the configuration space includes one or more of composition characteristics, processing characteristics, or microstructure characteristics.

7. The method of claim 1 wherein the one or more undesirable characteristics are selected from a group of material properties consisting of: coefficient of thermal expansion, thermal conductivity, electrical conductivity, density, strength, ductility, hardness, stiffness, transformation stress, transformation strain, magnetization, coercivity, magnetic susceptibility, material phase, and combinations thereof representing material performance indices.

8. The method of claim 1, wherein each sample of the plurality of samples comprises one or more material properties for the composition selected from the group consisting of: coefficient of thermal expansion, thermal conductivity, electrical conductivity, density, strength, ductility, hardness, stiffness, transformation stress, transformation strain, magnetization, coercivity, magnetic susceptibility, material phase, and combinations thereof representing material performance indices.

9. The method of claim 1, wherein the distinct location within configuration space is one of a plurality of locations in a regular grid or pseudo-randomly sampled location within configuration space.

10. The method of claim 1, wherein the cost function further comprises a path length objective.

11. The method of claim 1, wherein the free space within the configuration space is a complement of the one or more obstacle regions in the configuration space.

12. The method of claim 1, wherein the lack of monotonicity constraint is:
$${LOM}_{y} ( g ) = 2 min \{ {\int }_{0}^{y} {( \frac{d g}{d y} )}^{+} d λ , {\int }_{0}^{y} {( \frac{d g}{d y} )}^{-} d λ \} ,$$
where, LOM_{y}(g) is an index of lack of monotonicity of the function g,
$${\int }_{0}^{y} {( \frac{d g}{d y} )}^{+}$$
dλ is an index of Lack of Increase, and
$${\int }_{0}^{y} {( \frac{d g}{d y} )}^{-}$$
dλ is an index of Lack of Decrease.

13. The method of claim 1, wherein the property in the property model is one or more properties selected from the group consisting of coefficient of thermal expansion, density, strength, stiffness, phase stiffness, distortion under thermal gradients, transformation stress, transformation strain, and combinations thereof representing material performance indices.

14. The method of claim 1, further comprising: determining a rate at which the composition is changed for each material in the functionally graded material based on the optimal gradient path through the configuration space.

15. The method of claim 14, wherein the deposition rate is determined to create the functionally graded material with a desired property profile.

16. The method of claim 15 wherein the desired property profile is a linear property profile, a monotonic property profile, a non-linear property profile, or a non-monotonic property profile.

17. The method of claim 15, further comprising: generating a functionally graded material based at least on the optimal gradient path using a multi-material printer.

18. The method of claim 17, wherein the multi-material printer is a multi-material directed energy deposition printer, a multi-material laser/E-beam powder bed fusion printer, or a multi-material extrusion and sintering system.

19. A non-transitory computer-readable medium having stored instructions that, when executed by one or more processors, cause one or more computing devices to:
sample a multi-dimensional configuration space with a thermodynamic model of phase stability to determine a plurality of samples within the configuration space, wherein each sample comprises phase information of a composition at a distinct location within the configuration space;
determine an obstacle model based on the plurality of samples, the obstacle model defining one or more obstacle regions in the configuration space with one or more undesirable characteristics;
determine a free space within the configuration space in which a subset of the plurality of samples within the free space represent one or more desired material characteristics;
determine a property model that is valid within the free space of the configuration space model;
determine a cost function, wherein the cost function is a function of a property in the property model and comprises a lack of monotonicity objective; and
determine an optimal gradient path through the free space within the configuration space using a path planning algorithm that is configured to minimize the cost function.

20. A system, comprising:
a processor; and
a memory coupled to the processor, the memory stores instructions which when executed by the processor cause the system to:
sample a multi-dimensional configuration space with a thermodynamic model of phase stability to determine a plurality of samples within the configuration space, wherein each sample comprises phase information of a composition at a distinct location within the configuration space;
determine an obstacle model based on the plurality of samples, the obstacle model defining one or more obstacle regions in the configuration space with a property;
determine a free space within the configuration space in which a subset of the plurality of samples within the free space represent desired material phases;
determine a property model that is valid within the free space of the configuration space model;
determine a cost function, wherein the cost function is a function of a property in the property model and comprises a lack of monotonicity objective; and
determine an optimal gradient path through the free space within the configuration space using a path planning algorithm that is configured to minimize the cost function.
